(19) United States
(12) Patent Application Publication
(10) Pub. No.: US 2012/0022718 A1
(43) Pub. Date: Jan. 26, 2012

(54) METHOD OF CONTROLLING START/STOP OF A VEHICLE AT A TRAFFIC LIGHT

(75) Inventor: Vijay A. Neelakantan, Rochester Hills, MI (US)

(73) Assignee: GM GLOBAL TECHNOLOGY OPERATIONS, INC., Detroit, MI (US)

(21) Appl. No.: 12/841,237

(22) Filed: Jul. 22, 2010

(51) Int. Cl. G06F 7/00; G08G 1/095

(52) U.S. Cl. 701/2

(57) ABSTRACT

A method of controlling a vehicle stopped at a stop cycle of a traffic light includes broadcasting a signal indicating the time remaining in the stop cycle, and engaging a vehicle drive component, such as and engine of the vehicle and/or an auxiliary pump of the vehicle, prior to the end of the stop cycle when the time remaining in the stop cycle is less than a pre-determined time period.

### TECHNICAL FIELD

The invention generally relates to a method of controlling a vehicle at a traffic light.

### BACKGROUND

Vehicles powered by internal combustion engines only and including an automatic transmission, further include a transmission fluid pump coupled to the engine. The transmission fluid pump pressurizes a hydraulic fluid for the automatic transmission. The hydraulic fluid must remain pressurized when the vehicle is at a stop to ensure that the vehicle is ready for launch. Accordingly, the vehicle must maintain operation of the engine when the vehicle is at a stop.

Hybrid vehicles may include an engine and an electric motor. The engine may include but is not limited to an internal combustion engine, such as a gasoline engine. The engine may operate to drive the vehicle and/or power an electric generator, which charges a battery used to power the electric motor. Additionally, the engine may operate a pump that supplies pressurized hydraulic fluid to a transmission of the vehicle. The engine may be disengaged, i.e., turned off, when not needed for the operation of the hybrid vehicle. In order to provide the pressurized hydraulic fluid to the transmission, the vehicle may further include an electrically operated auxiliary pump that supplies the pressurized hydraulic fluid when the engine is not engaged. The auxiliary pump maintains operability of the automatic transmission for launching the hybrid vehicle so that the hybrid vehicle does not have to rely on the main engine pump to provide the hydraulic pressure to the automatic transmission for launch.

When the vehicle comes to a stop, such as at a traffic light presenting a “red” signal, the vehicle may turn off the engine to conserve fuel. However, before the vehicle may launch again upon the traffic light presenting a “green” signal, the engine or the auxiliary pump must be turned on, thereby slowing the launch of the vehicle. Alternatively, the hybrid vehicle may maintain operation of the engine and/or the auxiliary pump during the time the vehicle is stopped at the traffic light.

### SUMMARY

A method of controlling a vehicle at a traffic light is provided. The method includes broadcasting a cycle signal indicating the time remaining in a stop cycle of the traffic light, and engaging a vehicle drive component of the vehicle prior to the end of the stop cycle, when the time remaining in the stop cycle is less than a pre-determined time period.

A method of controlling a vehicle at a traffic light is also provided. The method includes sensing a speed of the vehicle, sensing a brake position of the vehicle, broadcasting a cycle signal from the traffic light indicating the time remaining in a stop cycle of the traffic light, disengaging a vehicle drive component of the vehicle when the time remaining in the stop cycle is greater than a pre-determined time period, when the sensed speed of the vehicle is equal to zero and when the sensed brake position of the vehicle is equal to a brake-on position. The method further includes engaging the vehicle drive component of the vehicle prior to the end of the stop cycle when the time remaining in the stop cycle is less than the pre-determined time period.

Accordingly, the cycle signal indicating the time remaining in the stop cycle of the traffic light is broadcast to the vehicle. The vehicle receives and processes the cycle signal, and engages the vehicle drive component when the time remaining in the stop cycle is less than the pre-determined time period. Accordingly, the vehicle may disengage the vehicle drive component upon stopping at a traffic light, with the broadcast cycle signal providing the information necessary to enable the vehicle to engage the vehicle drive component within the pre-determined time period prior to the end of the stop cycle, i.e., prior to the traffic light turning from red to green. As such, the vehicle does not need to maintain operation of the vehicle drive component during the entire stop cycle, but is prepared for launch immediately upon the stop cycle ending.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a first vehicle and a second vehicle at a traffic light.

FIG. 2 is a flow chart showing a method of controlling the first vehicle and the second vehicle at the traffic light.

### DETAILED DESCRIPTION

Referring to the Figures, wherein like numerals indicate like parts throughout the several views, a method of controlling a vehicle 20 at a traffic light 22 is shown generally at 24.

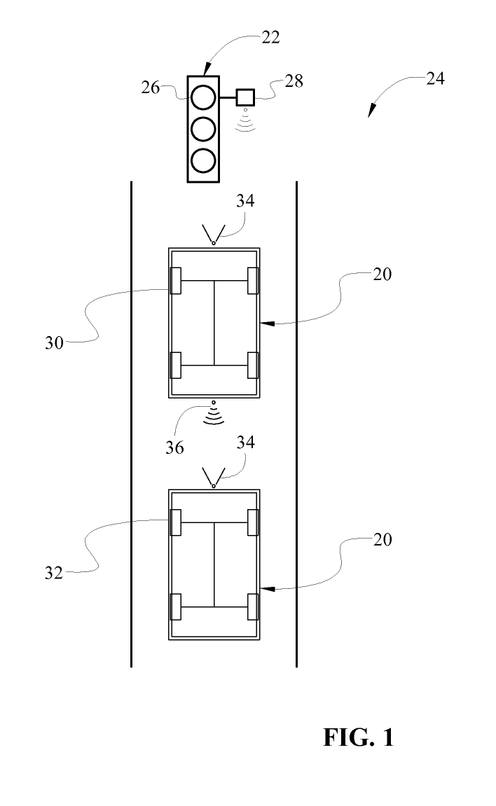

Referring to FIG. 1, the traffic light 22 may include any suitable size, type and/or style of traffic light 22. The traffic light 22 includes, but is not limited to, a red light 26. The red light 26 is illuminated during a stop cycle of the traffic light 22. The illuminated red light 26 indicates that oncoming traffic must stop. The traffic must remain at a stop until the red light 26 is no longer illuminated, indicating an end to the stop cycle.

The traffic light 22 includes a transmitter 28. The transmitter 28 broadcasts a wireless cycle signal to oncoming traffic associated with each specific red light 26. Accordingly, a traffic light 22 including four red lights 26, for example, may include four wireless cycle signals, each one associated with a specific red light 26. The transmitter 28 may include any suitable type and/or style of transmitter 28 capable of broadcasting a wireless signal to vehicles located at the traffic light 22. It should be appreciated that the transmitter 28 may be located directly on the traffic light 22, suspended above the roadway. Alternatively, the transmitter 28 may be located on a side of the roadway, near the traffic light 22, for example at or near a traffic light 22 control box.

A first vehicle 30 and a second vehicle 32 are shown stopped at the traffic light 22, with the second vehicle 32 stopped behind the first vehicle 30. The description of the vehicle 20 is applicable to both the first vehicle 30 and the second vehicle 32. Accordingly, the first vehicle 30 and the second vehicle 32 are not separately described in detail herein. While the same description applies to both the first vehicle 30 and the second vehicle 32, it should be appreciated that the first vehicle 30 and the second vehicle 32 may differ in make, model, size, shape, etc.

The vehicle 20 may include, but is not limited to, a vehicle powered by an internal combustion only, or a hybrid vehicle powered by a combination of an internal combustion engine and/or an electric motor. The vehicle 20 includes one or more vehicle drive components (not shown). The vehicle drive components may include any vehicle component necessary to power, drive and/or bring the vehicle from a stop into motion. The vehicle drive components may include, but are not limited to, an engine and a transmission. The engine may include, but is not limited to, an internal combustion engine such as a gasoline engine. The engine is coupled to the transmission and may be employed to supply torque to the transmission for driving the vehicle 20. If the vehicle 20 is a hybrid vehicle, then the vehicle drive components may further include an electric motor/generator. The electric motor/generator is coupled to the engine and the transmission. The electric motor/generator may be employed as an electric motor to supply torque to the transmission to drive the vehicle 20. Alternatively, the electric motor/generator may be powered by the engine to generate electricity to charge a battery of the vehicle 20. The vehicle drive components may further include an auxiliary transmission pump and/or a transmission accumulator. The auxiliary transmission pump and/or the transmission accumulator supplies and/or stores pressurized hydraulic fluid to the transmission when the engine is disengaged. Accordingly, the auxiliary transmission pump and/or the transmission accumulator allow for operation of the transmission when the engine is disengaged, such as when the electric motor/generator is being utilized to drive the vehicle 20. It should be appreciated that the vehicle 20 may include any suitable type and/or style of vehicle 20, and may include alternative power flow paths than described herein. Furthermore, the vehicle drive components of the vehicle 20 and the operation thereof, may differ from those described herein.

The vehicle 20 further includes a receiver 34. The receiver 34 is in communication with a vehicle controller (not shown). The receiver 34 receives the wireless cycle signal from the traffic light 22 associated with the red light 26, or may also receive a wireless signal from another vehicle. The receiver 34 may include any suitable type and/or style of receiver 34 capable of receiving the wireless signal from the traffic light 22, and communicating the wireless signal to the vehicle controller. The vehicle controller uses the received cycle signal to control one or more of the vehicle drive components as described below.

The vehicle 20 may further include a vehicle transmitter 36. The vehicle transmitter 36 broadcasts a wireless vehicular signal to other vehicles located directly behind the vehicle 20. The vehicle transmitter 36 may include any suitable type and/or style of transmitter 28 capable of broadcasting a wireless signal to other vehicles.

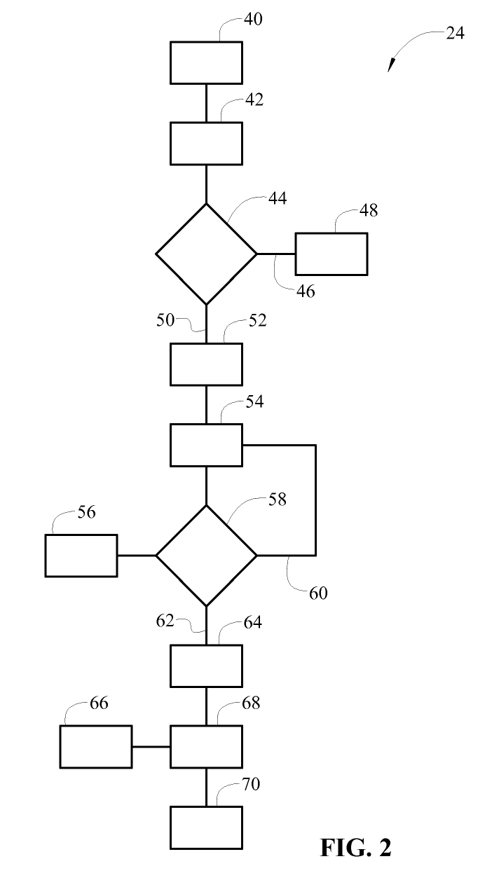

Referring to FIG. 2, the method of controlling the vehicle 20 includes sensing a speed of the vehicle 20, block 40. The speed of the vehicle may be sensed in any suitable manner, such as but not limited to, using a speed sensor disposed at one or more wheels of the vehicle. The speed of the vehicle is sensed to determine if the vehicle is moving or stationary.

The method further includes sensing a brake position of the vehicle 20, block 42. The brake position may be sensed in any suitable manner, such as but not limited to using a position sensor attached to a brake pedal of the vehicle 20. The brake position is sensed to determine if a braking system of the vehicle 20 is being applied, i.e., a brake-on position, or if the braking system is not being applied, i.e., a brake-off position. A brake-on position indicates that the vehicle 20 is stopped or attempting to stop at the traffic light 22. A brake-off position indicates that the vehicle 20 is not stopped at the traffic light 22 or is about to launch from a stop at the traffic light 22.

The method further includes determining if the sensed speed of the vehicle 20 is less than zero, equal to zero, or greater than zero, and determining if the sensed brake position of the vehicle 20 is equal to the brake-on position or the brake-off position, block 44. A speed greater than zero and a brake-off position indicates that the vehicle 20 is moving and not stopped at the traffic light 22, whereas a speed equal to zero and a brake-on position indicates that the vehicle 20 is stopped.

If the speed of the vehicle 20 is greater than zero, or if the brake position of the vehicle 20 is equal to the brake-off position, indicated at 46, then the method may further include maintaining normal operation of the vehicle 20, block 48. As discussed above, a speed greater than zero and/or a brake position equal to the brake-off position indicates that the vehicle 20 is not stopped at the traffic light 22. When the vehicle is not stopped at the traffic light 22, the method maintains the normal operation of the vehicle.

If the speed of the vehicle 20 is equal to zero, and if the brake position of the vehicle 20 is equal to the brake-on position, indicated at 50, then the method may further include defining a pre-determined time period, block 52. The pre-determined time period is the period of time the vehicle 20 may require to engage one or more vehicle drive components of the vehicle 20 in preparation for launch from a stop. Accordingly, the vehicle controller may disengage one or more of the vehicle drive components when the vehicle 20 is stopped to conserve fuel/energy. The pre-determined time period is the amount of time needed to then re-engage the vehicle drive components. The pre-determined time period may include any desirable time period, and may include an average of different time periods required for different vehicle drive components and/or different types, styles, makes and/or sizes of the vehicle 20.

The method may further include disengaging one or more of the vehicle drive components, block 54. As discussed above, a vehicle speed equal to zero and a brake position equal to the brake-on position indicates that the vehicle is stopped at the traffic light 22. Accordingly, when the vehicle 20 is at a stop, the vehicle controller may disengage the vehicle drive component, such as but not limited to, the engine of the vehicle, the auxiliary transmission pump, and/or the transmission accumulator to reduce energy consumption.

The method further includes broadcasting the cycle signal from the traffic light 22, block 56. As described above, the cycle signal indicates the time remaining in the stop cycle of the traffic light 22. Broadcasting the cycle signal from the traffic light 22 may be defined as broadcasting from the traffic light 22 suspended above the roadway, or from a side of the roadway near the traffic light 22.

The method further includes determining if the time remaining in the stop cycle is less than, equal to or greater than the pre-determined time period, block 58. The vehicle controller may compare the received cycle signal from the traffic light 22 to the pre-determined time period to determine if the time remaining in the stop cycle is less than, equal to or greater than the pre-determined time period.

When the time remaining in the stop cycle is greater than the pre-determined time period, indicated at 60, then the vehicle drive components remain disengaged, and the vehicle controller continues to monitor the time remaining in the stop cycle relative to the pre-determined time period.

When the time remaining in the stop cycle is less than the pre-determined time period, indicated at 62, then the method may further include engaging the vehicle drive component of the vehicle 20 prior to the end of the stop cycle, block 64. Accordingly, once the vehicle controller determines that time remaining in the stop cycle is less than pre-determined time period, then the vehicle controller may engage the vehicle drive component, i.e., start the engine and/or engage the auxiliary transmission pump, to prepare the vehicle to launch before the end of the stop cycle. This allows for a quick launch of the vehicle once the stop cycle ends, while conserving fuel/energy by disengaging the vehicle drive components when not needed.

When more than one vehicle 20 is stopped at the traffic light 22, such as shown in FIG. 1, then the time period required for the second vehicle 32 to engage any disengaged vehicle drive components must factor in the time required for the first vehicle 30 to launch. Accordingly, when more than one vehicle 20 is stopped at the traffic light 22, then the method may include sensing the broadcast cycle signal with the first vehicle 30 as described above, and broadcasting a vehicular signal from the vehicle transmitter 36 of the first vehicle 30 indicating an anticipated launch of the first vehicle 30, block 66. The anticipated launch of the first vehicle 30 may be determined, for example, when the brake position of the first vehicle 30 is equal to a brake-off position of the first vehicle 30, or when one or more of the vehicle drive components of the first vehicle 30 are engaged in response to the cycle signal being less than the pre-determined time period.

The method may further include sensing the broadcast vehicular signal from the first vehicle 30 with the second vehicle 32, block 68, and engaging one or more vehicle drive components of the second vehicle 32 in response to the sensed vehicular signal from the first vehicle 30 indicating the anticipated launch of the first vehicle 30, block 70.

While the best modes for carrying out the invention have been described in detail, those familiar with the art to which this invention relates will recognize various alternative designs and embodiments for practicing the invention within the scope of the appended claims.

1. A method of controlling a vehicle at a traffic light, the method comprising:
broadcasting a cycle signal indicating the time remaining in a stop cycle of the traffic light; and
engaging a vehicle drive component of the vehicle prior to the end of the stop cycle when the time remaining in the stop cycle is less than a pre-determined time period.

2. A method as set forth in claim 1 further comprising sensing a speed of the vehicle.

3. A method as set forth in claim 2 further comprising determining if the sensed speed of the vehicle is equal to or greater than zero.

4. A method as set forth in claim 3 further comprising sensing a brake position of the vehicle.

5. A method as set forth in claim 4 further comprising determining if the sensed brake position of the vehicle is equal to a brake-on position or a brake-off position.

6. A method as set forth in claim 5 further comprising maintaining normal operation of the vehicle when the time remaining in the stop cycle is greater than the pre-determined time period, and when one of the speed of the vehicle is greater than zero or the brake position of the vehicle is equal to the brake-off position.

7. A method as set forth in claim 6 further comprising disengaging the vehicle drive component when the speed of the vehicle is equal to zero and the brake position of the vehicle is equal to the brake-on position.

8. A method as set forth in claim 7 wherein the vehicle drive component of the vehicle includes at least one of an engine, an auxiliary transmission pump and a transmission accumulator.

9. A method as set forth in claim 1 further comprising defining the pre-determined time period.

10. A method as set forth in claim 1 further comprising sensing the broadcast cycle signal with a first vehicle.

11. A method as set forth in claim 10 further comprising broadcasting a vehicular signal from the first vehicle indicating an anticipated launch of the first vehicle.

12. A method as set forth in claim 11 further comprising sensing the broadcast vehicular signal from the first vehicle with a second vehicle.

13. A method as set forth in claim 12 further comprising engaging a vehicle drive component of the second vehicle in response to the sensed vehicular signal from the first vehicle indicating the anticipated launch of the first vehicle.

14. A method as set forth in claim 13 wherein broadcasting a vehicular signal indicating an anticipated launch of the first vehicle is further defined as broadcasting a vehicular signal indicating an anticipated launch when one of a brake position of the first vehicle is equal to a brake-off position and the vehicle drive component of the first vehicle is engaged.

15. A method as set forth in claim 13 wherein the vehicle drive component of the first vehicle includes at least one of an engine, an auxiliary transmission pump and a transmission accumulator.

16. A method as set forth in claim 1 wherein the traffic light includes a transmitter and broadcasting a cycle signal indicating the time remaining in a stop cycle of the traffic light is further defined as broadcasting a cycle signal from the transmitter of the traffic light indicating the time remaining in a stop cycle of the traffic light.

17. A method of controlling a vehicle at a traffic light, the method comprising:
sensing a speed of the vehicle;
sensing a brake position of the vehicle;
broadcasting a cycle signal from the traffic light indicating the time remaining in a stop cycle of the traffic light;
disengaging a vehicle drive component of the vehicle when the time remaining in the stop cycle is greater than a pre-determined time period, when the sensed speed of the vehicle is equal to zero and when the sensed brake position of the vehicle is equal to a brake-on position;
engaging the vehicle drive component of the vehicle prior to the end of the stop cycle when the time remaining in the stop cycle is less than the pre-determined time period.

18. A method as set forth in claim 17 further comprising maintaining normal operation of the vehicle when one of the sensed speed of the vehicle is greater than zero, and the sensed brake position of the vehicle is equal to a brake-off position.

19. A method as set forth in claim 18 further comprising broadcasting a vehicular signal from a first vehicle indicating an anticipated launch of the first vehicle.

20. A method as set forth in claim 19 further comprising engaging a vehicle drive component of a second vehicle in response to the sensed vehicular signal from the first vehicle indicating the anticipated launch of the first vehicle.
